(19) United States
(12) Patent Application Publication
(10) Pub. No.: US 2009/0278814 A1
(43) Pub. Date: Nov. 12, 2009

(54) TOUCH PANEL AND TOUCH DISPLAY COMPRISING THE SAME

(75) Inventors: CHIH-YAO FANG, Taichung County (TW); CHIEN-CHUNG KUO, Taichung County (TW); PING-WEN HUANG, Taichung County (TW)

Correspondence Address: WPAT, PC, 7225 BEVERLY ST., ANNANDALE, VA, 22003, US

(73) Assignee: WINTEK CORPORATION, TAICHUNG (TW)

(21) Appl. No.: 12/437,265

(22) Filed: May 7, 2009

(30) Foreign Application Priority Data
May 9, 2008 (TW) 097117093

(51) Int. Cl. G06F 3/041

(52) U.S. Cl. 345/173

(57) ABSTRACT

A touch panel and a touch display comprising the touch panel. The touch panel comprises: a top substrate comprising a communicating electrode formed thereon; a bottom substrate disposed on the top substrate, the bottom substrate being smaller than the top substrate so that a circumference of the top substrate overhangs a circumference of the bottom substrate; a plurality of dot spacers disposed between the bottom substrate and the top substrate; a conductive layer, extending from the communicating electrode on the top substrate to the circumference of the bottom substrate; and a flexible circuit board being electrically connected to one end of the conductive layer extending to the circumference of the bottom substrate. The touch display comprises the touch panel and a casing comprising a hollowed portion comprising a flange so that the touch panel is disposed in the hollowed portion.

### BACKGROUND OF THE INVENTION

1. Field of the Invention

The present invention generally relates to a touch panel and, more particularly, to a touch display with surface planarity and long lifetime.

2. Description of the Prior Art

Please refer to FIG. 1, which is a cross-sectional view of a resistive touch panel used in a conventional electronic device. The electronic device 10 comprises a casing 11. The casing 11 is a frame structure, in which a touch panel 12 is disposed. The electronic device 10 is not planar in appearance. When the surface of the touch panel 12 is being cleaned, it often occurs that the smirch is wedged between the casing 11 and the touch panel 12 to cause error operation. The lead wires in the circumference of the touch panel 12 are more fragile to cause poor reliability in the circumference of the touch panel 12.

Please refer to FIG. 2, which is a cross-sectional view of a resistive touch panel used in a conventional electronic device in Taiwan Pat. Appl. No. 096202890 “Improved Touch Panel Structure”. The touch panel 20 structure comprises a touch panel 21, whereon a decoration frame 22 and a cap film 23 are disposed so as to obtain a planar surface with the casing. However, since there is a flexible printed circuit board 25 disposed between the touch panel 21 and the substrate 24, there is non-uniformity between the touch panel 21 and the flexible printed circuit board 25.

Please refer to FIG. 3 and FIG. 4 for the cross-sectional views of the disclosure in U.S. Pat. Appl. No. 20070181456 “Electronic device with protection panel, protection panel, and method of fabricating protection panels”, which discloses a planar touch panel structure. The bottom substrate 31 of the touch panel 30 comprises a notch, through which a flexible printed circuit board 33 is disposed. The touch panel 30 is disposed in a space 41 enclosed by a casing 40 (as shown in FIG. 4) so as to achieve surface planarity for the surface 34 of the touch panel 30 and the surface 42 of the casing 40. However, there is difficulty in manufacturing the notch 32 in the bottom substrate 31, especially when the bottom substrate 31 is made of a material (such as glass) that makes it more difficult to form a notch.

### SUMMARY OF THE INVENTION

It is one object of the present invention to provide a touch panel and a touch display comprising the touch panel, so that surface planarity for the touch panel surface and casing surface can be achieved to further improve the reliability in the circumference and lengthen the long lifetime of the touch panel.

In order to achieve the foregoing object, the present invention provides a touch panel and a touch display comprising the touch panel. The touch panel comprises: a top substrate comprising a communicating electrode formed thereon; a bottom substrate disposed on the top substrate, the bottom substrate being smaller than the top substrate so that a circumference of the top substrate overhangs a circumference of the bottom substrate; a plurality of dot spacers disposed between the bottom substrate and the top substrate; a conductive layer, extending from the communicating electrode on the top substrate to the circumference of the bottom substrate; and a flexible circuit board being electrically connected to one end of the conductive layer extending to the circumference of the bottom substrate. The touch display comprises the touch panel and a casing comprising a hollowed portion comprising a flange so that the touch panel is disposed in the hollowed portion and the top substrate of the touch panel is positioned on the flange.

### BRIEF DESCRIPTION OF THE DRAWINGS

The objects, spirits and advantages of the preferred embodiments of the present invention will be readily understood by the accompanying drawings and detailed descriptions, wherein:

FIG. 1 is a cross-sectional view of a resistive touch panel used in a conventional electronic device;

FIG. 2 is a cross-sectional view of a resistive touch panel used in a conventional electronic device in Taiwan Pat. Appl. No. 096202890;

FIG. 3 and FIG. 4 are cross-sectional views of the disclosure in U.S. Pat. Appl. No. 20070181456;

FIG. 5 is a cross-sectional view of a touch panel according to one embodiment of the present invention;

FIG. 6 is a cross-sectional view of a touch panel according to another embodiment of the present invention; and

FIG. 7 is a cross-sectional view of a touch display comprising a touch panel according to the embodiment in FIG. 5 and a casing.

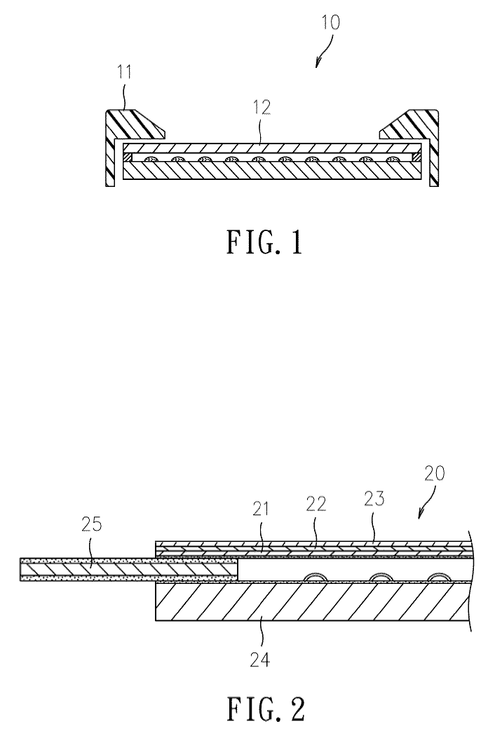

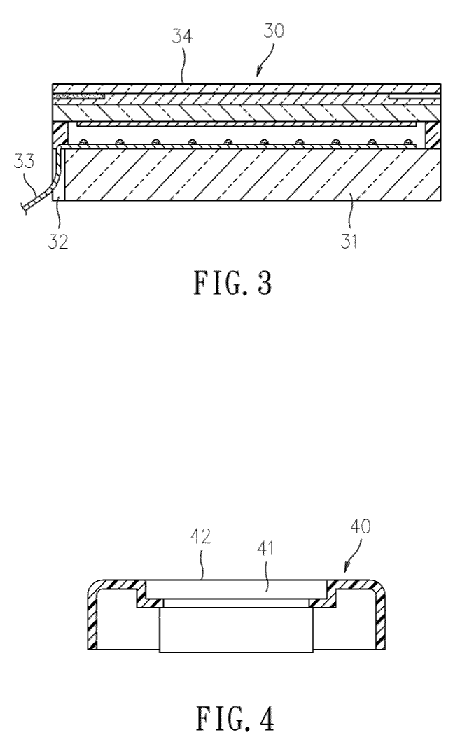

### DETAILED DESCRIPTION OF THE PREFERRED EMBODIMENT

The present invention can be exemplified by the preferred embodiments as described hereinafter.

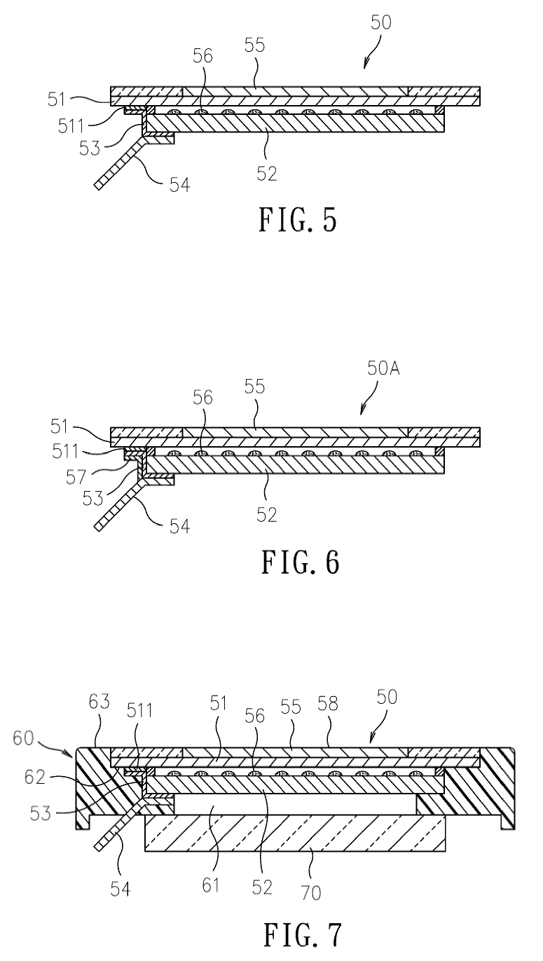

Please refer to FIG. 5, which is a cross-sectional view of a touch panel according to one embodiment of the present invention. The touch panel 50 comprises a top substrate 51. The top substrate 51 comprises a communicating electrode 511 formed thereon. On the surface of the top substrate 51, a decoration film 55 is formed. The decoration film 55 is transparent in the display region and non-transparent in the non-display region. A bottom substrate 52 is disposed on a surface of the top substrate 51 that is different from the other surface whereon the decoration film 55 is disposed. A plurality of dot spacers 56 are disposed between the bottom substrate 52 and the top substrate 51 so as to provide a cell gap between the bottom substrate 52 and the top substrate 51.

As shown in FIG. 5, the bottom substrate 52 is smaller than the top substrate 51 so that a circumference of the top substrate 51 overhangs a circumference of the bottom substrate 52. The communicating electrode 511 on the top substrate 51 is connected to a conductive layer 53, formed by screen printing or dispensing, to extend from the circumference of the bottom substrate 52 to one surface of the bottom substrate 52 different the other surface whereon the dot spacers 56 are disposed. In other words, the communicating electrode 511 on the top substrate 51 extends from the conductive layer 53 to the bottom substrate 52, and then from the conductive layer 53 to one side of the circumference of the bottom substrate 52 to be connected to a flexible circuit board 54.

Please refer to FIG. 6, which is a cross-sectional view of a touch panel according to another embodiment of the present invention. The touch panel 50A in FIG. 6 is similar to the embodiment in FIG. 5 except that the touch panel 50A further comprises a protection layer 57 on one surface of the conductive layer 53 to cover the conductive layer 53. The protection layer 57 is formed of an ultra-violet curing adhesive (UV adhesive) or any other adhesive.

Please refer to FIG. 7, which is a cross-sectional view of a touch display comprising a touch panel according to the embodiment in FIG. 5 and a casing. The casing 60 comprises a hollowed portion 61. The hollowed portion 61 comprises a flange 62 so that the touch panel 50 is disposed in the hollowed portion 61 and the top substrate 51 of the touch panel 50 is positioned on the flange 62. Moreover, a display panel 70 is further disposed on a bottom surface of the touch panel 50. As shown in FIG. 7, since the top substrate 51 of the touch panel 50 in the present invention is larger than the bottom substrate 52, the communicating electrode 511 on the top substrate 51 extends from the conductive layer 53 to the bottom substrate 52, and then from the conductive layer 53 to one side of the circumference of the bottom substrate 52 to be connected to a flexible circuit board 54.

Therefore, all the elements in the touch panel 50 are unchanged, without damaging the bottom substrate 52. In the present invention, the touch panel 50 is fixedly disposed in the casing 60 using an adhesive or a gripper and surface planarity can be achieved for the surface 58 of the touch panel 50 (or the surface of the decoration film 55) and the surface 63 of the casing 60 to achieve easy assembly, improve the reliability in the circumference and lengthen the long lifetime of the touch panel.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. A touch panel, comprising:
a top substrate comprising a communicating electrode formed thereon;
a bottom substrate disposed on the top substrate, the bottom substrate being smaller than the top substrate so that a circumference of the top substrate overhangs a circumference of the bottom substrate;
a plurality of dot spacers disposed between the bottom substrate and the top substrate;
a conductive layer, extending from the communicating electrode on the top substrate to the circumference of the bottom substrate; and
a flexible circuit board being electrically connected to one end of the conductive layer extending to the circumference of the bottom substrate.

2. The touch panel as recited in claim 1, wherein the conductive layer further extends from circumference of the bottom substrate to one side of the bottom substrate different from the other side whereon the dot spacers are disposed.

3. The touch panel as recited in claim 1, wherein the conductive layer is formed by screen printing or dispensing.

4. The touch panel as recited in claim 1 or 3, wherein the conductive layer comprises a protection layer formed thereon to cover the conductive layer.

5. The touch panel as recited in claim 1, wherein the protection layer comprises an ultra-violet curing adhesive (UV adhesive) or any other adhesive.

6. A touch display, comprising:
a touch panel, comprising:
a top substrate comprising a communicating electrode formed thereon;
a bottom substrate disposed on the top substrate, the bottom substrate being smaller than the top substrate so that a circumference of the top substrate overhangs a circumference of the bottom substrate;
a plurality of dot spacers disposed between the bottom substrate and the top substrate;
a conductive layer, extending from the communicating electrode on the top substrate to the circumference of the bottom substrate;
a flexible circuit board being electrically connected to one end of the conductive layer extending to the circumference of the bottom substrate; and
a casing, comprising a hollowed portion comprising a flange so that the touch panel is disposed in the hollowed portion and the top substrate of the touch panel is positioned on the flange.

7. The touch display as recited in claim 6, wherein the conductive layer further extends from circumference of the bottom substrate to one side of the bottom substrate different from the other side whereon the dot spacers are disposed.

8. The touch display as recited in claim 6, wherein the conductive layer is formed by screen printing or dispensing.

9. The touch display as recited in claim 6 or 8, wherein the conductive layer comprises a protection layer formed thereon to cover the conductive layer.

10. The touch display as recited in claim 6, wherein the protection layer comprises an ultra-violet curing adhesive (UV adhesive) or any other adhesive.
